(19) United States
(12) Patent Application Publication
(10) Pub. No.: US 2016/0272862 A1
(43) Pub. Date: Sep. 22, 2016

(54) Heat Transfer Compositions, Systems, and Methods

(71) Applicant: Bluon Energy LLC, McClellan, CA (US)

(72) Inventors: Peter Capuciati, Stamford, CT (US); Max Champie, Buena Vista, CA (US)

(21) Appl. No.: 15/160,989

(22) Filed: May 20, 2016

Related U.S. Application Data
(63) Continuation-in-part of application No. 15/130,713, filed on Apr. 15, 2016.
Application No. 15/130,713 is a continuation-in-part of application No. 14/536,422, filed on Nov. 7, 2014.
(60) Provisional application No. 62/165,711, filed on May 22, 2015.
(60) Provisional application No. 62/072,931, filed on Oct. 30, 2014.
(60) Provisional application No. 62/009,102, filed on Jun. 6, 2014.

(51) Int. Cl. C09K 5/04

(52) U.S. Cl. CPC C09K 5/045; C09K 2205/43; C09K 2205/22

(57) ABSTRACT

Heat transfer compositions, methods, efficiencies, and systems are disclosed. The compositions have four or more heat transfer components/constituents that have been selected such that the compositions provide a flammability rating of Al or better as defined by IS0817:2014, and a 14% or greater variance-to-liquid pressure at a temperature of 37.8° C. (100° F.). The compositions also reduce the amount of R125 needed to achieve a flammability rating of Al or better. The method of designing an HCFC-free heat transfer composition includes selecting four or more constituents with staggered boiling temperatures and blending the constituents together.

This application claims priority to U.S. Provisional Application Ser. No. 62/165711, filed May 22, 2015, and is a continuation-in-part of U.S. patent application Ser. No. 15/130713, filed Apr. 15, 2016, which is a continuation-in-part of U.S. patent application Ser. No. 14/536422, filed Nov. 7, 2014, which claims the benefit of priority to U.S. Provisional Application No. 62/072931, filed Oct. 30, 2014, and U.S. Provisional Application No. 62/009102, filed Jun. 6, 2014. These and all other extrinsic materials discussed herein are incorporated by reference in their entirety.

### FIELD OF THE INVENTION

The field of the invention is heat transfer compositions, systems, and methods.

### BACKGROUND

The background description includes information that may be useful in understanding the present invention. It is not an admission that any of the information provided herein is prior art or relevant to the presently claimed invention, or that any publication specifically or implicitly referenced is prior art.

Heat transfer fluids (e.g., refrigerants) are commonly used in various heat transfer systems, including air conditioning, refrigeration, freezers, heaters, and the like. Many formulations for heat transfer fluids are known.

At the time this application is filed, the synthetic HCFC refrigerants, such as R12 or R22 (cholordifluoromethane), are currently being phased out in many developed countries due to its ozone depletion potential (ODP) and high global warming potential (GWP). There is currently a need for new compositions of heat transfer compositions that can serve as a replacement for HCFCs and that have improved ODP and GWP.

HCFC refrigerants have a long history of use and are known to have high performance and heat transfer efficiency. An ideal replacement composition would not only need to be HCFC-free, but also preferably has a flammability rating of A1 and a variance-to-liquid pressure of 14% or greater, in order to provide similar or better performance and efficiencies than the current HCFC refrigerants.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for an HCFC-free heat transfer composition that has a flammability rating of A1 or better and a 14% or greater variance-to-liquid pressure.

### SUMMARY OF THE INVENTION

The inventive subject matter provides apparatus, systems and methods in which an HCFC-free heat transfer composition has at least first, second, third, and fourth components, the amounts of which are selected such that the heat transfer composition has (i) a flammability rating of A1 or better, as defined by IS0817:2014, and (ii) a 14% or greater variance-to-liquid pressure at a temperature of 37.8° C. (100° F.). The variance-to-liquid pressure is the ratio between liquid pressure and vapor pressure of the composition at 100 ° F. over the liquid pressure of the composition at 37.8° C. (100° F.). In addition, the composition preferably contains low amounts of R125 to achieve a flammability rating of A1 or better. For example, the amount of R125 in the composition is preferably no more than 10% by weight of the total weight of the composition. Alternatively, when R32 is present in the composition, then the amount of R125 in the composition is preferably no more than 60% by weight of the weight of R32.

In some embodiments, the amounts of the at least first, second, third, and fourth additional constituents are also selected such that the heat transfer composition has a liquid-to-vapor pressure differential of at least 27 PSIG at a temperature of 37.8° C. (100° F.). In addition, other aspects of some embodiments, the amount of constituents are selected such that the pressure differential ranges from about 193 PSIG in liquid phase to about 165 PSIG in vapor phase.

In addition, the amounts of the at least first, second, third, and fourth additional constituents may be further selected such that the heat transfer composition has a liquid pressure of about 195 PSIG or less at a temperature of 37.8° C. (100° F.). In other aspects, the amounts of the at least first, second, third, and fourth additional constituents may be further selected such that the heat transfer composition has a vapor pressure of about 166 PSIG or less at a temperature of 37.8° C. (100° F.).

In some preferred embodiments, the transfer composition maintains a 14% or greater variance-to-liquid pressure across a temperature range of 32.2° C. (90° F.) to 110° F.

In one preferred embodiment, the first constituent comprises R32, the second constituent comprises R125, the third constituent comprises R134a, and the fourth constituent comprises R227ea. In some embodiments, these constituents are be present in the following percentages: R32 present in an amount of 15-25% by weight; R125 present in an amount of 1-5% by weight; R134a present in an amount of 50-70% by weight; and R227ea present in an amount of 10-20% by weight. It is also contemplated that the composition could further comprise a fifth constituent. The fifth constituent could comprise R236 present in an amount of 0.5-3.5% by weight.

In some embodiments, the heat transfer compositions described herein have a latent heat of vaporization of at least 230 kJ/kg and a vapor phase pressure at 37.8° C. (100° F.) of less than 170 PSIG at 37.8° C. (100° F.).

It is further contemplated that the heat transfer compositions described herein can be used in a heat transfer system such as an HVAC system.

In other aspects, the inventive subject matter includes a method of achieving a 14% or greater variance-to-liquid pressure at a temperature of 37.8° C. (100° F.) for an HCFC-free heat transfer composition having a flammability rating of A1 or better as defined by IS0817:2009. The method comprises the step of selecting an amount at least first, second, third, and fourth additional constituents, wherein: (i) the second constituent has a higher boiling temperature than the first constituent at 14.696 PSIA; (ii) the third constituent has a higher boiling temperature than the second constituent at 14.696 PSIA; and (iii) the fourth constituent has a higher boiling temperature than the third constituent at 14.696 PSIA.

In some embodiments, the method further comprises the step of combining the selected amounts of the at least first, second, third, and fourth additional constituents. In other aspects, the selected amount of the first constituent is between 15-25% by weight of R32, the selected amount of the second constituent is an amount of 1-5% by weight of R125, the selected amount of the third constituent is an amount of 50-70% by weight of R134a, and the selected amount of the third constituent is an amount of 10-20% by weight of R227ea.

In yet other aspects of the inventive method, the amounts of the at least first, second, third, and fourth additional constituents are further selected such that: a) the first additional constituent boils at between −90° C. and −60° C. at 14.696 PSIA; b) the second additional constituent boils at between −55° C. and −35° C. at 14.696 PSIA; c) the third additional constituent boils at between −40° C. and −20° C. at 14.696 PSIA; and d) the fourth additional constituent boils at between −25° C. and −5° C. at 14.696 PSIA.

The inventive subject matter also includes an HCFC-free heat transfer composition for a heat transfer system, comprising at least first, second, third, and fourth additional constituents, and wherein the amounts of the at least first, second, third, and fourth additional constituents are selected such that the heat transfer composition has (i) a flammability rating of Al or better as defined by IS0817:2009, and (ii) a 27 PSIG or greater difference between the liquid pressure and the vapor pressure of the composition at 37.8° C. (100° F.). In one aspect of some embodiments, the amounts of the at least first, second, third, and fourth additional constituents are further selected such that the heat transfer composition has a 14% or greater variance-to-liquid pressure at a temperature of 37.8° C. (100° F.).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates the staggered boiling points of five different heat transfer fluid components at varying temperatures and pressures.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It is contemplated that an ideal R22 replacement minimizes environmental impact characteristics (e.g., GWP and ODP) and hazard potential (e.g., flammability, toxicity), while maximizing efficiency (e.g., reduced equipment amperage) and compatibility with existing refrigerant systems (e.g., compatibility with mineral oil as a lubricant). Thus, one aspect of the inventive subject matter includes a novel HCFC-free R22 replacement that maximizes efficiency and compatibility with existing systems, while minimizing environmental impact and flammability.

Most R22 replacement components have competing disadvantages and advantages, which means that most R22 replacement compositions are less than ideal. The inventors have unexpectedly discovered that the heat transfer compositions disclosed herein have a measured operating performance and energy efficiency that are comparable to, or better than, the performance of R22 and R22 replacements. Thus, in some embodiments, the disclosed compositions have been developed to (i) deliver operating performance that is comparable with R22 and (ii) reduce energy consumption compared to R22 through reduced equipment amperage and reduced run-times. As a result of increased energy efficiency, the mechanical and operational load of the heat transfer system is reduced in measurable amounts, where the result can be characterized through reduced energy consumption.

More specifically Applicant has discovered a new approach for designing an HCFC-free heat transfer composition for a heat transfer system. The contemplated compositions meet the criteria for an effective HCFC refrigerant replacement. In particular, the contemplated compositions not only have improved ozone depletion potential (ODP) and high global warming potential (GWP) values, but also have a flammability rating of Al or better as defined by IS0817:2014, and a 14% or greater variance-to-liquid pressure at a temperature of 37.8° C. (100° F.). As a result, the inventive compositions described herein provide an HCFC-free R22 replacement that performs equal to or better than R22.

Table 1 below shows the constituents for eight exemplary compositions of the inventive subject matter. Compositions 1-8 are a non-exhaustive list of compositions that demonstrate the inventive principles described herein. As can be seen from Table 1, compositions 1-8 all have four or more constituents.

TABLE 1
Constituents of Eight HCFC-Free Heat Transfer Compositions

| Composition | R32 | R125 | R1234yf | R134a | R1234ze | R227ea | R236fa |
|---|---|---|---|---|---|---|---|
| Composition 1 | 18% | 3% | | 65% | | 14% | |
| Composition 2 | 16% | 5% | | 66% | | 10% | 3% |
| Composition 3 | 21% | 4% | | 61% | | 14% | 1% |
| Composition 4 | 18% | 9% | | 53% | 10% | 10% | |
| Composition 5 | 21% | 4% | | 61% | | 12% | 3% |
| Composition 6 | 21% | 4% | | 60% | | 15% | |
| Composition 7 | 20% | 5% | | 62% | | 12% | 1% |
| Composition 8 | 19% | 9% | 5% | 56% | | 11% | |

Table 2 below compares the characteristics of these eight exemplary compositions to various conventional heat transfer compositions.

TABLE 2
Characteristics of R22 Replacements @ 37.8° C. (100° F.)

| | Liquid Phase | Vapor Phase | | | | |
|---|---|---|---|---|---|---|
| | @ 37.8° C. | @ 37.8° C. | | % Variance | % Variance | Flammability |
| Composition | (kPa) | (kPa) | Delta | to Liquid | to Vapor | Classification |
| Composition 1 | 185.2 | 159.0 | 26 | 14.2% | 16.5% | A1 |
| Composition 2 | 180.6 | 154.5 | 26 | 14.5% | 16.9% | A1 |
| Composition 3 | 192.8 | 164.4 | 28 | 14.7% | 17.3% | A1 |
| Composition 4 | 193.2 | 165.3 | 28 | 14.4% | 16.9% | A1 |
| Composition 5 | 196.3 | 168.8 | 28 | 14.03% | 16.32% | A1 |
| Composition 6 | 193.2 | 164.7 | 29 | 14.75% | 17.3% | A1 |
| Composition 7 | 192.1 | 162.5 | 30 | 15.4% | 18.2% | A1 |
| Composition 8 | 194.9 | 166.1 | 29 | 14.8% | 17.3% | A1 |
| R424A | 188.8 | 172.4 | 16 | 8.7% | 9% | A1 |
| R426A | 131.8 | 128.6 | 3 | 2.5% | 3% | A1 |
| R427A | 215.8 | 189.9 | 26 | 12.0% | 14% | A1 |
| R428A | 254.0 | 251.6 | 2 | 0.9% | 1% | A1 |
| R434A | 227.3 | 219.4 | 8 | 3.5% | 4% | A1 |
| R437A | 148.3 | 136.4 | 12 | 8.0% | 9% | A1 |
| R438A | 210.6 | 187.3 | 23 | 11.1% | 12% | A1 |
| R442A | 252.0 | 221.9 | 30 | 12.0% | 14% | A1 |
| R448A | 244.2 | 215.8 | 28 | 11.6% | 13% | A1 |
| R449A | 240.1 | 213.1 | 27.0 | 11.2% | 13% | A1 |
| R449B | 241.0 | 213.9 | 27.1 | 11.2% | 13% | A1 |
| R449C | 224.5 | 197.2 | 27.3 | 12.1% | 14% | A1 |
| R453A | 211.9 | 182.2 | 30 | 14.01% | 16.30% | A1 |

Compositions 1-8 have a 14% or greater variance-to-liquid pressure at a temperature of 37.8 ° C. (100° F.) wherein the variance-to-liquid pressure is the ratio of the difference between liquid pressure and vapor pressure of the composition at 37.8 ° C. (100° F.) over the liquid pressure of the composition at 37.8 ° C. (100° F.). In addition, compositions 1-8 all have a flammability classification of Al. In contrast, the conventional heat transfer compositions shown in table 2 have less than 14% variance-to-liquid pressure at a temperature of 37.8 ° C. (100° F.), with the exception of R453A. However, R453A contains a large amount of R125, which is used to reduce flammability of the blended composition. (R453A comprises R32/R125/R134a/R227ea/600/601a as follows: 20%/20%/53.8%/5%/0.6%/0.6%). The inventive compositions described herein provide a14% variance-to-liquid pressure at a temperature of 37.8 ° C. (100° F.) and a flammability classification of A1 while keeping R125 under 10%.

Compositions 1-8 are representative of a new approach for designing R22 replacements. The design approach optimizes the heat transfer properties (e.g., latent heat of vaporization, energy consumed per run time) of each individual constituent in the blended composition by selecting constituents with staggered boiling temperatures. The advantage of selecting constituents with staggered boiling temperatures is described in detail in co-owned patent application Ser. Nos. 15/130713, 14/536422, and PCT/US15/34564, which are incorporated herein by reference in their entirety.

One common trend in R22 placement compositions is to utilize components with a low GWP, which can result in an overall lower GWP for the resulting blend. For example, in many applications, R32 is a popular R22 replacement because it has desirable environmental performance (GWP of 675 and an ODP of 0.00). Additionally, R32 has similar performance metrics as R22. One disadvantage of R32 is its flammability (ASHRAE Safety Group A2). Additionally, R32 is not miscible with mineral oil. For more details on R32 as an R22 replacement component, see “World's First Adoption of R32, a Refrigerant With Low Global Warming Potential,” Daikin Group CSR Report (2013).

Additionally, many known R22 replacement compositions contain the component R134a. R134a is a desirable component because it has an ODP of zero. However, many blends only contain R134a in moderate amounts (often <50%) because R134a has a moderate GWP potential (1430). One additional disadvantage to R134a is that it is not miscible with mineral oil.

Another common component in many R22 replacement compositions is R125. Many R22 replacement compositions use R125 in large amounts (often >25%) because of R125′s fire suppression properties. However, R125 has a very high GWP (3500) and is not miscible with mineral oil.

The inventors have discovered the surprising fact that certain blends of components in novel quantities can greatly outperform similar R22 replacement compositions. In one aspect of the inventive subject matter, the inventors have discovered a combination of specific heat transfer components with sequenced or spaced ‘boiling points’ which produces a superior heat transfer capability. The improvement over existing R22 replacements is greater than would otherwise be expected based on the individual and collective chemical heat absorption attributes of each constituent.

One previously unappreciated reason for this improvement is that staggered boiling points create a ‘domino’ effect as each individual constituent reaches its boiling point. This ‘domino’ effect maximizes each component's heat absorption until the heat absorption begins to be saturated. When the heat absorption capacity of an individual component starts to saturate, the next sequential constituent reaches its boiling point, which maximizes each component's heat absorption until it starts to saturate. This is true for each heat transfer component, which creates a more consistent phase change during the liquid-to-gas and gas-to-liquid phase changes across the evaporator and condenser coils of the equipment. This effect is best illustrated with at least four heat transfer components, and is further illustrated with five or more heat transfer components that have sequenced boiling points.

The inventive subject matter provides heat transfer compositions that have at least four heat transfer components that have been purposely selected to provide staggered boiling points and related P/T charts. Five possible heat transfer components and their respective boiling points are provided below (see also Table 1):

1. R32: boils at −51.7° C. (−61.0° F.)

2. R125: boils at −48.5° C. (−55.3° F.)

3. R134a: boils at −26.3° C. (−15.3° F.)

4. R227ea: boils at −16.4° C. (+2.5° F.)

5. R236fa: boils at −1.4° C. (+29.5° F.)

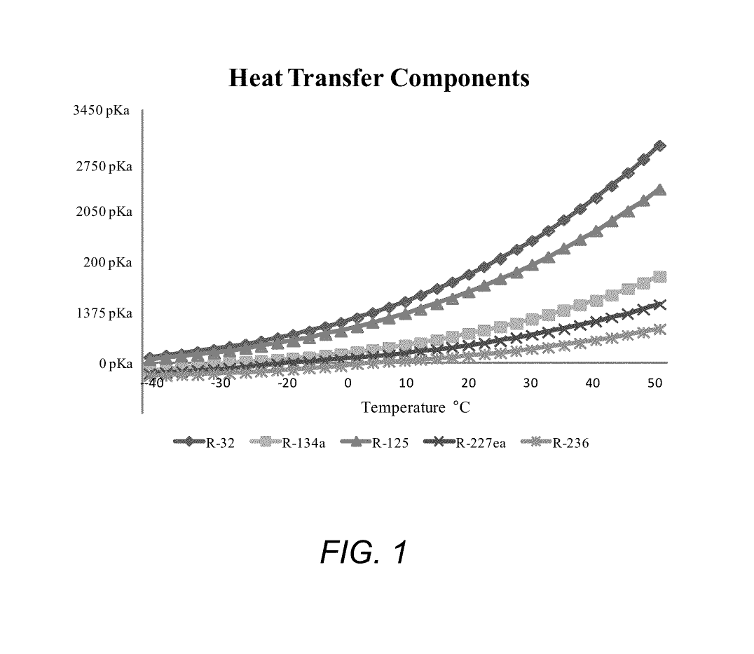

The pressure/temperature graph in FIG. 1 illustrates the sequenced (e.g., “stacked” or “staggered”) nature of these five heat transfer components. While R32, R125, R134a, R227ea, and R236fa are shown in FIG. 1, the inventive subject matter includes alternative heat transfer components that have similar characteristics (e.g., flammability, boiling temperature/pressure, GWP, ODP, etc.) to provide a heat transfer composition with comparable performance to R22 and reduced energy consumption compared to R22. For example, the heat transfer composition could included R32 present in an amount of 15-25% by weight, R125 present in an amount of 1-5% by weight, and three additional components that have boiling temperatures within the ranges of −55° C. (−67° F.) and −35° C. (−31° F.), −40° C. (-40° F.) and - 20° C. (68° F.), and -25° C. (-13° F.) and −5° C. (23° F.), respectively, at 101.3 kPA (14.696 PSIA). The three additional components are preferably selected such that the heat transfer composition has (i) a flammability rating of A1 or better as defined by IS0817:2014, and (ii) a 14% or greater variance-to-liquid pressure at a temperature of 37.8° C. (100° F.), wherein the variance-to-liquid pressure is the ratio of the difference between liquid pressure and vapor pressure of the composition at 37.8° C. (100° F.) over the liquid pressure of the composition at 37.8° C. (100° F.), and (iii) no more than 10% by weight of R125 (or no more than 60% by weight of R32). Those of ordinary skill in the art will also appreciate that new heat transfer components developed after the filing of this application may also be used consistently with the inventive principles described herein to provide a heat transfer composition that accomplishes the stated objectives (e.g., staggered boiling temperatures, improved latent heat of vaporization, lower liquid/vapor phase pressure, acceptable flammability, etc.).

It should also be appreciated that the additional heat transfer components could be selected based on their partial pressures at a given temperature rather than, or in addition to, their boiling temperatures. For example, the first additional component could have a partial pressure between 503.3 kPa (73 PSIG) and 641.2 kPa (93 PSIG) at 0° C. (32° F.), 737.7 kPa (107 PSIG) and 875.6 kPa (127 PSIG) at 10° C. (50° F.), and/or 1606 kPa (233 PSIG) and 1744 kPa (253 PSIG) at 35° C. (95° F.). The second additional component could have a partial pressure between 124.1 kPa (18 PSIG) and 262 kPa (38 PSIG) at 0° C. (32° F.), 241.3 kPa (35 PSIG) and 379.2 kPa (55 PSIG) at 10° C. (50° F.), and/or 717.1 kPa (104 PSIG) and 854.9 kPa (124 PSIG) at 35° C. (95° F.). The third component could have a partial pressure between 27.58 kPa (4 PSIG) and 165.5 kPa (24 PSIG) at 0° C. (32° F.), 110.3 kPa (16 PSIG) and 248.2 kPa (36 PSIG) at 10° C. (50° F.), and/or 441.3 kPa (64 PSIG) and 579.2 kPa (84 PSIG) at 35° C. (95° F.).

The proposed combinations of components are unexpected for many reasons. For example, although R32 is a highly effective refrigerant, it has a flammable rating and high operating pressure that increases electricity consumption. As a result, many R22 replacements do not utilize R32.

However, the disclosed compositions use multiple flame-retarding or flame-inhibiting constituents with varying boiling points and operating pressures to offset both the flammability and high operating pressure of R32. The sequence spaced boiling points of the multiple constituents effectively offset the flammability and high operating pressure of R32 to provide a non-flammable composition, high variance-to-liquid pressure, energy efficient, and highly effective heat transfer composition. In sum, the inventors have discovered a unique combination of R22 replacement components that, when blended together, not only optimize flammability, GWP, and ODP, but also provide unexpected improvements in performance and efficiency compared to known refrigerant blends made of similar components.

The inventive subject matter also includes compositions that maintain a 14% or greater variance-to-liquid pressure across a temperature range of 32.2° C. (90° F.) to 37.8° C. (100° F.). Table 9 below shows the variance-to-liquid pressure at 32.2° C. (90° F.) to 37.8° C. (100° F.) for compositions 1-8. As can be seen from table 3 below, compositions 1-8 all maintain a 14% or greater variance-to-liquid pressure across a temperature range of 32.2° C. (90° F.) to 37.8° C. (100° F.).

TABLE 3
Characteristics of R22 Replacements at 32.2° C. (90° F.)

| | | | | | Flamma- |
|---|---|---|---|---|---|
| | Liquid Phase | Vapor Phase | | % Vari- | bility |
| | @ 37.8° C. | @ 37.8° C. | | ance to | Classifi- |
| Composition | (kPa) | (kPa) | Delta | Liquid | cation |
| Composition 1 | 158.61 | 134.36 | 24 | 15.3% | A1 |
| Composition 2 | 154.57 | 130.42 | 24 | 15.6% | A1 |
| Composition 3 | 165.35 | 139.03 | 26 | 15.9% | A1 |
| Composition 4 | 165.79 | 139.93 | 26 | 15.6% | A1 |
| Composition 5 | 168.51 | 142.97 | 26 | 15.2% | A1 |
| Composition 6 | 165.7 | 139.3 | 26 | 15.9% | A1 |
| Composition 7 | 164.8 | 137.3 | 28 | 16.7% | A1 |
| Composition 8 | 167.22 | 140.58 | 27 | 15.9% | A1 |

One should appreciate that the disclosed techniques provide many advantageous technical effects including heat transfer fluids for heat transfer systems that provide improved performance metrics.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. If there is any ambiguity between corresponding English units and SI units, the ambiguity should be resolved in favor of SI units, and the English units being regarded as approximations.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. An HCFC-free heat transfer composition for a heat transfer system, comprising:
at least first, second, third, and fourth additional constituents; and
wherein the amounts of the at least first, second, third, and fourth additional constituents are selected such that the heat transfer composition has (i) a flammability rating of A1 or better as defined by IS0817:2014, and (ii) a 14% or greater variance-to-liquid pressure at a temperature of 37.8° C. (100° F.), wherein the variance-to-liquid pressure is the ratio of the difference between liquid pressure and vapor pressure of the composition at 37.8° C. (100° F.) over the liquid pressure of the composition at 37.8° C. (100° F.), and (iii) no more than 10% by weight of R125.

2. The heat transfer composition of claim 1, wherein the amounts of the at least first, second, third, and fourth additional constituents are further selected such that the heat transfer composition has a liquid-to-vapor pressure differential of at least 27 PSIG at a temperature of 37.8° C. (100° F.).

3. The heat transfer composition of claim 2, wherein the pressure differential ranges from about 193 PSIG in liquid phase to about 165 PSIG in vapor phase.

4. The heat transfer composition of claim 1, wherein the amounts of the at least first, second, third, and fourth additional constituents are further selected such that the heat transfer composition has a liquid pressure of about 195 PSIG or less at a temperature of 37.8° C. (100° F.).

5. The heat transfer composition of claim 1, wherein the amounts of the at least first, second, third, and fourth additional constituents are further selected such that the heat transfer composition has a vapor pressure of about 166 PSIG or less at a temperature of 37.8° C. (100° F.).

6. The heat transfer composition of claim 1, wherein the composition maintains a 14% or greater variance-to-liquid pressure across a temperature range of 32.2° C. (90° F.) to 37.8° C. (100° F.).

7. The heat transfer composition of claim 1, wherein:
the first constituent comprises R32;
the second constituent comprises R125;
the third constituent comprises R134a; and
the fourth constituent comprises R227ea.

8. The heat transfer composition of claim 7, wherein the constituents are present in the following percentages:
R32 present in an amount of 15-25% by weight;
R125 present in an amount of 1-5% by weight;
R134a present in an amount of 50-70% by weight; and
R227ea present in an amount of 10-20% by weight.

9. The heat transfer composition of claim 8, further comprising a fifth constituent comprising R236 present in an amount of 0.5-3.5% by weight.

10. The heat transfer composition of claim 1, wherein the composition has a latent heat of vaporization of at least 230 kJ/kg and a vapor phase pressure at 37.8° C. (100° F.) of less than 170 PSIG at 37.8° C. (100° F.).

11. The heat transfer composition of claim 1, wherein the heat transfer system is an HVAC system.

12. A method of achieving a 14% or greater variance-to-liquid pressure at a temperature of 37.8° C. (100° F.) for an HCFC-free heat transfer composition having a flammability rating of Al or better as defined by IS0817:2009, wherein the variance-to-liquid pressure is the ratio of the difference between liquid pressure and vapor pressure of the composition at 37.8° C. (100° F.) over the liquid pressure of the composition at 37.8° C. (100° F.), the method comprising:
selecting an amount at least first, second, third, and fourth additional constituents, wherein:
the second constituent has a higher boiling temperature than the first constituent at 14.696 PSIA;
the third constituent has a higher boiling temperature than the second constituent at 14.696 PSIA; and
the fourth constituent has a higher boiling temperature than the third constituent at 14.696 PSIA.

13. The method of claim 12, further comprising the step of combining the selected amounts of the at least first, second, third, and fourth additional constituents.

14. The method of claim 13, wherein:
the selected amount of the first constituent is between 15-25% by weight of R32;
the selected amount of the second constituent is an amount of 1-5% by weight of R125;
the selected amount of the third constituent is an amount of 50-70% by weight of R134a;
and the selected amount of the fourth constituent is an amount of 10-20% by weight of R227ea.

15. The method of claim 12, wherein the amounts of the at least first, second, third, and fourth additional constituents are further selected such that:
a) the first additional constituent boils at between −90° C. and −50° C. at 14.696 PSIA;
b) the second additional constituent boils at between −55° C. and −35° C. at 14.696 PSIA;
c) the third additional constituent boils at between −40° C. and −20° C. at 14.696 PSIA; and
d) the fourth additional constituent boils at between −27° C. and −5° C. at 14.696 PSIA.

16. An HCFC-free heat transfer composition for a heat transfer system, comprising:
at least first, second, third, and fourth additional constituents, wherein the first constituent optionally comprises R32;
wherein the amounts of the at least first, second, third, and fourth additional constituents are selected such that the heat transfer composition has (i) a flammability rating of A1 or better as defined by IS0817:2009, and (ii) a 27 PSIG or greater difference between the liquid pressure and the vapor pressure of the composition at 37.8° C. (100° F.); and
wherein the amounts of the at least first, second, third, and fourth additional constituents are further selected such that R125 is present in either (i) no more than 10% by weight of the composition, or (ii) no more than 60% by weight of R32.

17. The heat transfer composition of claim 16, wherein the amounts of the at least first, second, third, and fourth additional constituents are further selected such that the heat transfer composition has a 14% or greater variance-to-liquid pressure at a temperature of 37.8° C. (100° F.), wherein the variance-to-liquid pressure is the ratio of the difference between liquid pressure and vapor pressure of the composition at 37.8° C. (100° F.) over the liquid pressure of the composition at 37.8° C. (100° F.).

18. The heat transfer composition of claim 16, wherein the first constituent comprises R32 and the second constituent comprises R125, and wherein the first, second, third, and fourth additional constituents are further selected such that R125 is present in (i) no more than 10% by weight of the composition, and (ii) no more than 60% by weight of R32.

19. An HCFC-free heat transfer composition for a heat transfer system, comprising:
at least first, second, third, and fourth additional constituents, wherein the first constituent comprises R32 and the second constituent optionally comprises R125; and
wherein the amounts of the at least first, second, third, and fourth additional constituents are selected such that the heat transfer composition has (i) a flammability rating of A1 or better as defined by IS0817:2014, (ii) a 14% or greater variance-to-liquid pressure at a temperature of 37.8° C. (100° F.), wherein the variance-to-liquid pressure is the ratio of the difference between liquid pressure and vapor pressure of the composition at 37.8° C. (100° F.) over the liquid pressure of the composition at 37.8° C. (100° F.), and (iii) R125 is less than 60% by weight of R32.

20. The heat transfer composition of claim 19, wherein R32 is present in an amount of 15-25% by weight.
